(19) United States
(12) Patent Application Publication
(10) Pub. No.: US 2011/0024529 A1
(43) Pub. Date: Feb. 3, 2011

(54) Electrostatic atomizer

(75) Inventors: Jumpei Oe, Osaka (JP); Hiroshi Suda, Osaka (JP); Takafumi Omori, Osaka (JP); Takayuki Nakada, Osaka (JP)

Correspondence Address: BACON & THOMAS, PLLC, 625 SLATERS LANE, FOURTH FLOOR, ALEXANDRIA, VA, 22314-1176, US

(73) Assignee: PANASONIC ELECTRIC WORKS CO., LTD., Osaka (JP)

(21) Appl. No.: 12/805,374

(22) Filed: Jul. 28, 2010

(30) Foreign Application Priority Data
Jul. 28, 2009 (JP) 2009-175905

(51) Int. Cl. B05B 5/00

(52) U.S. Cl. 239/704

(57) ABSTRACT

An electrostatic atomizer includes a discharge electrode, an opposite electrode positioned in front of the discharge electrode in a spaced-apart relationship therewith, a housing for defining an atomization chamber between the discharge electrode and the opposite electrode, a water supply unit for supplying water for atomization to the discharge electrode, and a voltage application unit for applying a voltage to the discharge electrode. The housing is provided with an air vent window through which the atomization chamber is opened laterally outwards. The opposite electrode is provided with a soundproof shield portion extended therefrom to cover, when seen from a front side of the opposite electrode, the space existing laterally outwards of the air vent window of the housing. The soundproof shield portion reflects rearwards a discharge sound generated in the atomization chamber.

### FIELD OF THE INVENTION

The present invention relates to an electrostatic atomizer and, more particularly, a technique of reducing the discharge sound emitted frontwards.

### BACKGROUND OF THE INVENTION

Conventionally, there are known electrostatic atomizers capable of generating charged water particulates. Japanese Patent Application Publication No. 2007-144425 discloses one example of the electrostatic atomizers which includes a discharge electrode, an opposite electrode positioned in a spaced-apart relationship with the discharge electrode and a water supply unit for supplying water for atomization to the discharge electrode. In this electrostatic atomizer, if a voltage is applied to the discharge electrode, the water adhering to the discharge electrode is subjected to electrostatic atomization, consequently generating charged water particulates which are discharged frontwards.

The term “frontwards” used herein denotes the side at which the opposite electrode is positioned in an opposing relationship with the discharge electrode.

However, the electrostatic atomizer of the afore-mentioned configuration suffers from a problem in that the discharge sound generated from the discharge electrode is emitted frontwards, thus becoming a operation noise. This is because the discharge sound is likely to be amplified in an atomization chamber defined between the discharge electrode and the opposite electrode.

As a solution to this problem, it may be contemplated that a sound absorption device for absorbing the discharge sound emitted frontwards is additionally provided to prevent generation of noises. In this case, a problem is posed in that the provision of the sound absorption device leads to an increase in the overall device size and in the production cost.

### SUMMARY OF THE INVENTION

In view of the above, the present invention provides a small-sized cost-effective electrostatic atomizer capable of reducing the discharge sound emitted frontwards.

In accordance with an embodiment of the invention, there is provided an electrostatic atomizer, including: a discharge electrode; an opposite electrode positioned in front of the discharge electrode in a spaced-apart relationship therewith; a housing for defining an atomization chamber between the discharge electrode and the opposite electrode; a water supply unit for supplying water for atomization to the discharge electrode; and a voltage application unit for applying a voltage to the discharge electrode, wherein the housing is provided with an air vent window through which the atomization chamber is opened laterally outwards, and wherein the opposite electrode is provided with a soundproof shield portion extended therefrom to cover, when seen from a front side of the opposite electrode, the space existing laterally outwards of the air vent window of the housing, the soundproof shield portion reflecting rearwards a discharge sound generated in the atomization chamber.

With this configuration, it is possible for the soundproof shield portion to reflect rearwards the discharge sound emitted laterally outwards through the air vent window, although the discharge sound is generated from the discharge electrode within the atomization chamber and then echo-amplified within the atomization chamber. In other words, the soundproof shield portion restrains the amplified discharge sound from propagating toward the front side (namely, the side where there exists a space to which the charged water particulates are discharged). Moreover, there is no need to additionally provide a sound absorption device or the like. This eliminates the possibility of incurring an increase in the overall size of the atomizer and in the cost.

In the electrostatic atomizer, the voltage application unit may include a lead line leading to the discharge electrode, and the housing is provided with an insulation plate positioned between the lead line and the opposite electrode, the insulation plate including a reflector wall for reflecting the discharge sound generated in the atomization chamber toward the air vent window.

With this configuration, the discharge sound amplified within the atomization chamber is reflected toward the air vent window by the reflector wall of the insulation plate and then reflected rearwards by the soundproof shield portion extending laterally outwards away from the air vent window. This helps restrain the amplified discharge sound from being discharged to the front side. Since the insulation plate is interposed between the lead line and the opposite electrode, the overall height of the atomizer can be reduced by bringing the opposite electrode into proximity to the lead line.

In the electrostatic atomizer, the opposite electrode may include a dome-shaped body portion disposed around a tip of the discharge electrode and a tubular electrode portion extending toward the front side from the dome-shaped body portion.

In the electrostatic atomizer of the present invention, the housing is provided with an air vent window through which the atomization chamber is opened laterally outwards. The opposite electrode includes a soundproof shield portion for, when seen from the front side, covering the space existing laterally outwards of the air vent window of the housing. The soundproof shield portion is designed to reflect rearwards the discharge sound generated within the atomization chamber. This provides an advantageous effect in that it is possible to reduce the noise emitted to the front side and to avoid an increase in the overall size of the atomizer and in the cost.

In addition, there is provided an advantageous effect in that the size of the soundproofing electrostatic atomizer can be further reduced by interposing the insulation plate with a reflector wall between the lead line and the opposite electrode.

### BRIEF DESCRIPTION OF THE DRAWINGS

The objects and features of the present invention will become apparent from the following description of embodiments, given in conjunction with the accompanying drawings, in which:

FIG. 1 is a side section view showing an electrostatic atomizer in accordance with a first embodiment of the present invention;

FIG. 2A is a side section view an electrostatic atomizer in accordance with a second embodiment of the present invention and FIG. 2B is a front view thereof;

FIG. 3 is a side view showing an electrostatic atomizer in accordance with a third embodiment of the present invention;

FIG. 4 is a section view of the electrostatic atomizer taken along the line IV-IV in FIG. 3; and

FIG. 5A is a top plan view of the electrostatic atomizer shown in FIG. 3 with an opposite electrode attached thereto and FIG. 5B is a front view thereof with the opposite electrode removed for clarity.

### DETAILED DESCRIPTION OF THE PREFERRED EMBODIMENTS

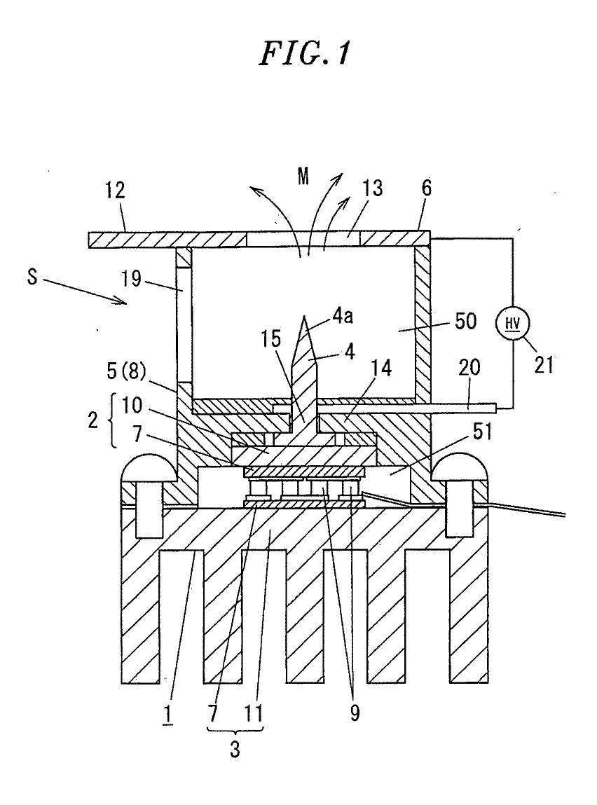

Embodiments of the present invention will be described in detail with reference to the accompanying drawings which form a part hereof. In FIG. 1, there is shown an electrostatic atomizer in accordance with a first embodiment of the present invention.

The electrostatic atomizer of the present embodiment makes use of a Peltier unit 1 including a radiator part 3 and a cooler part 2. A discharge electrode 4 is connected to the cooler part 2 of the Peltier unit 1 so that the cooler part 2 can cool the discharge electrode 4. A support frame 5 is connected to the Peltier unit 1 to support an opposite electrode 6 at the tip end thereof, whereby the discharge electrode 4 and the opposite electrode 6 are fixed in a spaced-apart opposing relationship with each other. In the present embodiment, the support frame 5 makes up a housing 8 of the electrostatic atomizer.

The Peltier unit 1 is of the type in which thermoelectric elements 9 are interposed between a pair of Peltier circuit plates 7. Heat is transferred from one of the Peltier circuit plates 7 to the other by supplying an electric current to the thermoelectric elements 9 electrically connected to one another. In the present embodiment, a cooling plate 10 is connected to the Peltier circuit plate 7 arranged at the upper side in FIG. 1. The upper one of the Peltier circuit plates 7 and the cooling plate 10 make up the cooler part 2. A fin-shaped radiator body 11 is connected and fixed to the Peltier circuit plate 7 arranged at the lower side in FIG. 1. The lower one of the Peltier circuit plates 7 and the radiator body 11 makes up the radiator part 3.

The support frame 5 is made of an insulating material and formed into a tubular shape. One axial end of the support frame 5 is connected to the radiator body 11 of the Peltier unit 1 while the opposite electrode 6 is supported by and connected to the other axial end of the support frame 5. A partition wall 14 for bisecting the internal space of the support frame 5 into an atomization chamber 50 and a sealing chamber 51 is installed on the inner circumferential surface of the support frame 5. A communication hole 15 through which the atomization chamber 50 communicates with the sealing chamber 51 is provided at the center of the partition wall 14.

The discharge electrode 4 is formed into a circular column shape and has a discharging tip portion 4a. In order to connect the support frame 5 to the Peltier unit 1, the discharge electrode 4 is fitted through the communication hole 15 while positioning the tip portion 4a within the atomization chamber 50 and bringing the base end into contact with the cooler part 2 of the Peltier unit 1 within the sealing chamber 51.

An air vent window 19 is provided in a portion of the side circumferential wall of the support frame 5 defining the atomization chamber 50. The opposite electrode 6 has a discharge hole 13. The atomization chamber 50 communicates with the external space through the air vent window 19 and the discharge hole 13 of the opposite electrode 6. A voltage-applying lead line 20 is connected at one end to the discharge electrode 4 within the support frame 5 and at the other end to a voltage application unit 21 arranged outside the support frame 5. The voltage application unit 21 applies a high voltage for electrostatic atomization between the discharge electrode 4 and the opposite electrode 6.

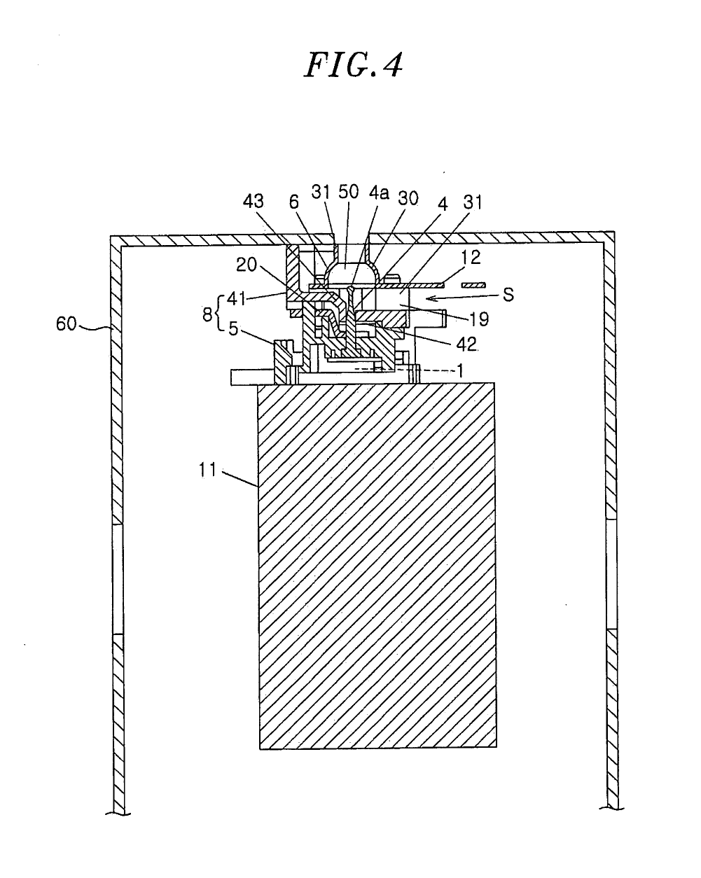

A soundproof shield portion 12 extends laterally outwards from the outer circumferential portion of the opposite electrode 6. The soundproof shield portion 12 aims at reflecting the discharge sound generated within the atomization chamber 50. The soundproof shield portion 12 is arranged to hide a whole space S existing outside the air vent window 19 of the support frame 5 in a casing 60 (see FIG. 4) (hereinafter referred to as “out-of-window space S”) when seen from the front side (i.e., when seen in a direction from the opposite electrode 6 towards the discharge electrode 4).

Although the soundproof shield portion 12 is provided to hide the entirety of the out-of-window space S in the present embodiment, the present invention is not limited thereto. In other words, the out-of-window space S may not be fully covered with the soundproof shield portion 12. The soundproof shield portion 12 may be provided to cover most of the out-of-window space S or only the area of the out-of-window space S making great contribution to emitting sound in a direction that the charged water particulates are discharged.

In the electrostatic atomizer of the present embodiment configured as described above, if the thermoelectric elements 9 sealed within the sealing chamber 51 by the interconnection of the support frame 5 and the radiator body 11 is supplied with an electric current, the discharge electrode 4 is cooled through the cooler part 2 due to the heat transfer within the thermoelectric elements 9. Thus, condensed water is produced on the surface of the discharge electrode 4 that gathers the moisture present in the air within the atomization chamber 50. In the present embodiment, the cooler part 2 of the Peltier unit 1 for cooling the discharge electrode 4 serves as a water supply unit for supplying water for atomization to the discharge electrode 4.

If the voltage application unit 21 applies a high voltage to the discharge electrode 4 holding water in the tip portion 4a thereof so that electric charges can concentrate on the tip portion 4a of the discharge electrode 4 as a negative electrode, the water held at the tip portion 4a is repeatedly subjected to Rayleigh fission by a great deal of energy. This generates a large quantity of charged water particulates M having a diameter of nanometer size. The charged water particulates M are moved toward the opposite electrode 6 and then discharged frontwards through the discharge hole 13 of the opposite electrode 6. In this regard, a fresh ambient air is introduced through the air vent window 19 into the space around the discharge electrode 4 within the atomization chamber 50, which assures stable supply of the moisture used in generating the charged water particulates M. Moreover, the charged water particulates M are vigorously discharged to the outside because they come into the stream of the air introduced into the support frame 5 from the air vent window 19 and discharged from the discharge hole 13.

In the meantime, a discharge sound is generated from the tip portion 4a of the discharge electrode 4 within the atomization chamber 50. The discharge sound is echoed and eventually amplified within the atomization chamber 50. In the present embodiment, the opposite electrode 6 positioned at the front side of the atomization chamber 50 is provided with the soundproof shield portion 12 extending laterally outwards. This ensures that the discharge sound emitted laterally outwards through the air vent window 19 is reflected rearwards by the soundproof shield portion 12.

Presence of the soundproof shield portion 12 restrains the amplified discharge sound from propagating frontwards (i.e., toward the side where there exists a space to which the charged water particulates M are discharged). This makes it possible to solve the problem of generating operation noise. Since the generation of operation noise can be suppressed by merely extending the soundproof shield portion 12 from the opposite electrode 6, the electrostatic atomizer can be prevented from becoming large-sized and costly.

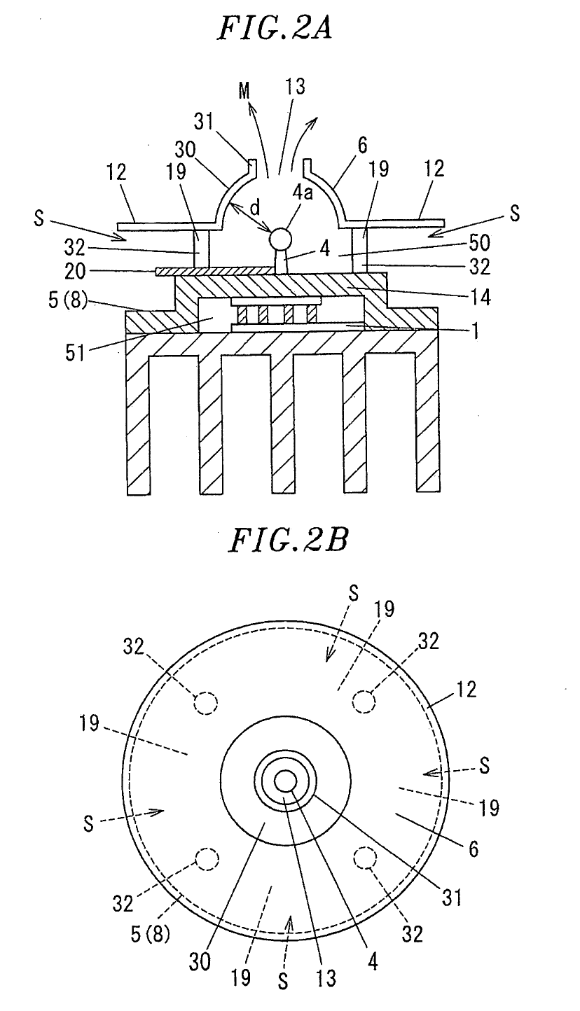

Next, an electrostatic atomizer in accordance with a second embodiment of the present invention will be described with reference to FIGS. 2A and 2B. The same configurations of the present embodiment as those of the first embodiment described earlier will be omitted from detailed description. Hereinafter, only the characterizing configurations distinguished from the configurations of the first embodiment will be described in detail.

In the present embodiment, the opposite electrode 6 includes a dome-shaped body portion 30 protruding frontwards to surround the discharge hole 13 of the opposite electrode 6. The body portion 30 is formed to ensure that the distance d between the inner surface thereof and the tip portion 4a of the discharge electrode 4 becomes uniform. As a result, strong electric fields are generated in the extensive three-dimensional range between the body portion 30 of the opposite electrode 6 and the tip portion 4a of the discharge electrode 4. Thus, the degree of concentration of the electric fields on the tip portion 4a of the discharge electrode 4 grows very high. This makes it possible to efficiently concentrate electric charges on the water held by the discharge electrode 4, thereby generating charged water particulates M.

The shape of the body portion 30 of the opposite electrode 6 is not limited to the dome shape shown in FIGS. 2A and 2B. It will be all right if at least a portion of the inner surface of the body portion 30 surrounding the tip portion 4a of the discharge electrode 4 has a cross-sectional shape that conforms to the arc line described about the tip portion 4a of the discharge electrode 4 with a radius equal to the shortest distance d between the tip portion 4a of the discharge electrode 4 and the opposite electrode 6.

A tubular electrode portion 31 is formed at the peripheral edge of the discharge hole 13 of the body portion to extend frontwards (i.e., away from the discharge electrode 4). As a result, electric fields are also generated between the inner circumferential surface of the tubular electrode portion 31 and the tip portion 4a of the discharge electrode 4. This makes it possible to further increase the degree of concentration of the electric fields on the tip portion 4a of the discharge electrode 4. The charged water particulates M generated in a large quantity are introduced into the discharge hole 13 and attracted to the inner circumferential surface of the tubular electrode portion 31 and then discharged through the tubular electrode portion 31.

In the present embodiment, the opposite electrode 6 is supported by and fixed to the tip portions of a plurality of (four, in the illustrated example) support posts 32 upstanding from the support frame 5. The atomization chamber 50 is defined between the support posts 32 and the partition wall 14 of the support frame 5 and the opposite electrode 6. The lateral sides of the atomization chamber 50 are all opened to the outside except the portions where the support posts 32 exist. In other words, the open portions between the adjoining support posts 32 serve as air vent windows 19 through which the atomization chamber 50 is opened laterally outwards.

A soundproof shield portion 12 is formed in the outer periphery of the ring-shaped opposite electrode 6 to extend along the entire perimeter thereof. When seen from the front side, the entirety of the out-of-window space S is hidden by the soundproof shield portion 12.

In the electrostatic atomizer of the present embodiment configured as above, the charged water particulates M can be efficiently generated by the dome-shaped body portion 30 of the opposite electrode 6 but the discharge sound generated within the atomization chamber 50 is likely to be amplified due to the curvature of the body portion 30. However, the discharge sound thus amplified is reflected rearwards by the soundproof shield portion 12 of the opposite electrode 6 and consequently restrained from being discharged frontwards as a noise.

In the present embodiment, the efficiency of generating the charged water particulates M is improved by the dome-shaped body portion 30 and the tubular electrode portion 31, which makes it possible to generate a sufficiently large quantity of charged water particulates M even with a small-sized atomizer. In addition, a soundproof unit can be provided by merely extending the soundproof shield portion 12 from the opposite electrode 6. This eliminates the possibility that the size of the electrostatic atomizer is unnecessarily increased. With the electrostatic atomizer of the present embodiment, therefore, it is possible to reduce the noise while securing a required quantity of charged water particulates M. Moreover, it becomes possible to achieve a reduction in the overall size of the electrostatic atomizer and in the cost.

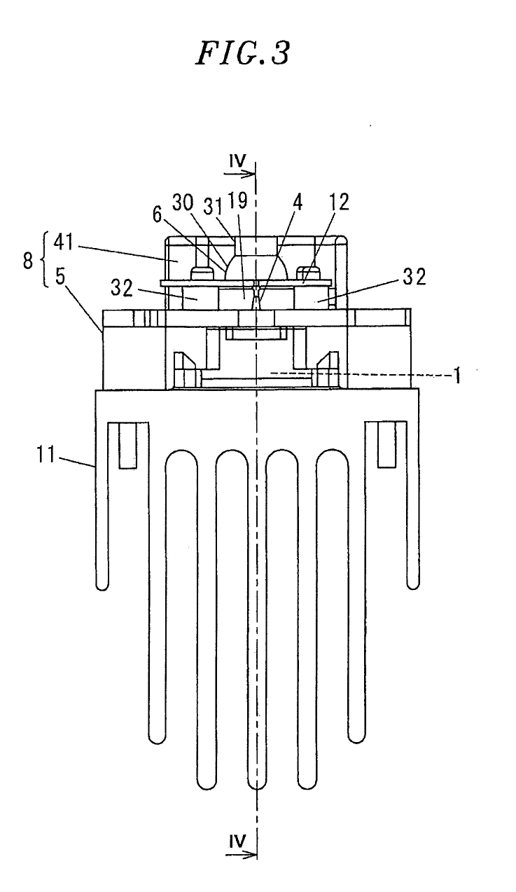

Next, an electrostatic atomizer in accordance with a third embodiment of the present invention will be described with reference to FIGS. 3, 4, 5A and 5B. The same configurations of the present embodiment as those of the first and second embodiments described earlier will be omitted from detailed description. Hereinafter, only the characterizing configurations distinguished from the configurations of the first and second embodiments will be described in detail.

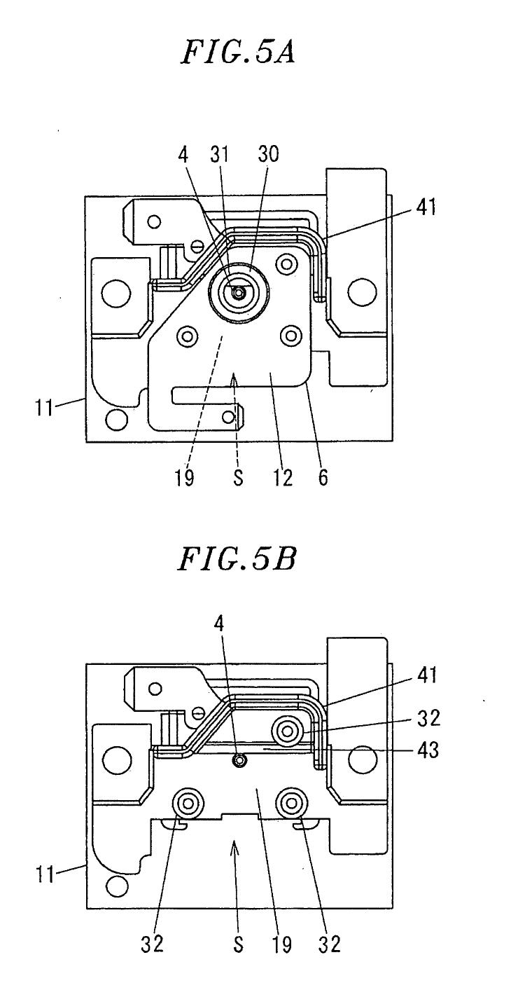

FIG. 3 is a side view showing the electrostatic atomizer of the third embodiment. FIG. 4 is a section view of the electrostatic atomizer taken along line IV-IV in FIG. 3. FIG. 5A is a front view of the electrostatic atomizer of the third embodiment with the opposite electrode attached thereto and FIG. 5B is a front view thereof with the opposite electrode removed for clarity.

The opposite electrode 6 of the present embodiment is supported by and fixed to the end portions of three support posts 32 upstanding from the support frame 5. An insulation plate 41 is fixed to the support frame 5 so that it can be positioned between the lead line 20, through which to apply a voltage to the discharge electrode 4, and the opposite electrode 6 (see FIG. 4). The insulation plate 41 is provided with a through hole 42 through which the discharge electrode 4 passes. A reflector wall 43 for reflecting the discharge sound generated from the tip portion 4a of the discharge electrode 4 toward air vent windows 19 is formed near the through hole 42 of the insulation plate 41. The reflector wall 43 is inclined laterally outwards so that it can come closer to the opposite electrode 6 as it goes away from the discharge electrode 4.

In the present embodiment, the support frame 5 and the insulation plate 41 fixed thereto make up a housing 8. An atomization chamber 50 in which the tip portion 4a of the discharge electrode 4 lies is formed between the housing 8 and the opposite electrode 6. The lateral sides of the atomization chamber 50 are opened to the outside except the portions where the support posts 32 exist and the portion where the reflector wall 43 of the insulation plate 41 exists. In other words, the open portions between the adjoining support posts 32 and the portion where the reflector wall 43 of the insulation plate 41 does not exist, serve as air vent windows 19 through which the atomization chamber 50 is opened laterally outwards.

A soundproof shield portion 12 is provided in the outer peripheral portion of the opposite electrode 6 to extend away from the reflector wall 43 of the insulation plate 41. This ensures that the area of the out-of-window space S making greater contribution to emitting sound (i.e., the opposite side of the discharge electrode 4 to the reflector wall 43 of the insulation plate 41) in a direction that the charged water particulates are discharged is hidden by the soundproof shield portion 12 when seen from the front side.

In the electrostatic atomizer of the present embodiment configured as above, the charged water particulates M can be efficiently generated by the dome-shaped body portion 30 and the tubular electrode portion 31 of the opposite electrode 6 but the discharge sound generated within the atomization chamber 50 is likely to be amplified due to the curvature of the body portion 30. However, the discharge sound thus amplified is reflected toward the air vent windows 19 by the reflector wall 43 of the insulation plate 41 and then reflected rearwards by the soundproof shield portion 12 extending away from the air vent windows 19. This helps restrain the discharge sound from being released frontwards.

In the present embodiment, the efficiency of generating the charged water particulates M is improved by the dome-shaped body portion 30 and the tubular electrode portion 3, which makes it possible to generate a sufficiently large quantity of charged water particulates M even with a small-sized atomizer. In addition, a soundproof unit can be provided by merely extending the soundproof shield portion 12 from the opposite electrode 6. This eliminates the possibility that the size of the electrostatic atomizer is unnecessarily increased.

Since the insulation plate 41 is interposed between the lead line 20 leading to the discharge electrode 4 and the opposite electrode 6, insulation can be secured even when the overall height of the atomizer is reduced by bringing the opposite electrode 6 into proximity to the lead line 20. This helps further reduce the size of the electrostatic atomizer.

With the electrostatic atomizer of the present embodiment, therefore, it is possible to reduce the noise while securing a required quantity of charged water particulates M. Moreover, it becomes possible to achieve a reduction in the overall size of the electrostatic atomizer and in the cost.

Proper design changes in the foregoing embodiments or suitable combination of the respective embodiments may be made without departing from the intended scope of the invention.

While the invention has been shown and described with respect to the embodiments, it will be understood by those skilled in the art that various changes and modification may be made without departing from the scope of the invention as defined in the following claims.

What is claimed is:

1. An electrostatic atomizer, comprising:
a discharge electrode;
an opposite electrode positioned in front of the discharge electrode in a spaced-apart relationship therewith;
a housing for defining an atomization chamber between the discharge electrode and the opposite electrode;
a water supply unit for supplying water for atomization to the discharge electrode; and
a voltage application unit for applying a voltage to the discharge electrode,
wherein the housing is provided with an air vent window through which the atomization chamber is opened laterally outwards, and
wherein the opposite electrode is provided with a soundproof shield portion extended therefrom to cover, when seen from a front side of the opposite electrode, the space existing laterally outwards of the air vent window of the housing, the soundproof shield portion reflecting rearwards a discharge sound generated in the atomization chamber.

2. The electrostatic atomizer of claim 1, wherein the voltage application unit includes a lead line leading to the discharge electrode, and the housing is provided with an insulation plate positioned between the lead line and the opposite electrode, the insulation plate including a reflector wall for reflecting the discharge sound generated in the atomization chamber toward the air vent window.

3. The electrostatic atomizer of claim 1, wherein the opposite electrode includes a dome-shaped body portion disposed around a tip of the discharge electrode and a tubular electrode portion extending toward the front side from the dome-shaped body portion.
